(19) United States
(12) Patent Application Publication
(10) Pub. No.: US 2025/0336252 A1
(43) Pub. Date: Oct. 30, 2025

(54) SECURITY MONITORING USING NON-VISIBLE SIGNALS

(71) Applicant: Alarm.com Incorporated, Tysons, VA (US)

(72) Inventors: Martin McMullan, Sullivan’s Island, SC (US); Glenn Tournier, Vienna, VA (US); Adam Brandfass, Pittsburgh, PA (US); Seton Paul Kasmir, San Diego, CA (US)

(21) Appl. No.: 19/190,025

(22) Filed: Apr. 25, 2025

Related U.S. Application Data
(60) Provisional application No. 63/640,045, filed on Apr. 29, 2024.

(51) Int. Cl. G07C 9/29; G06V 20/52; G06V 40/10

(52) U.S. Cl. CPC G07C 9/29; G06V 20/52; G06V 40/10

(57) ABSTRACT

Methods, systems, and apparatus, including computer programs encoded on computer storage media, for security monitoring using nonvisible signals. One of the methods includes obtaining, from an imaging device, a set of images of one or more physical locations surrounding or including an area of a property; detecting a human depicted in the set of images; determining whether the set of images includes an indication of a non-visible energy signal emitted by a wearable device worn by the human; and determining that the human has permission to access the area of the property in response to determining that the set of images includes the indication of the non-visible energy signal emitted by the wearable device worn by the human.

### CROSS REFERENCE TO RELATED APPLICATIONS

This application claims the benefit of U.S. Provisional Application No. 63/640,045, filed Apr. 29, 2024, which is incorporated herein by reference in its entirety for all purposes.

### TECHNICAL FIELD

This disclosure relates generally to access control systems.

### BACKGROUND

Many properties are equipped with security systems that include sensors and connected system components. A security system can be used to monitor for unauthorized access to a property.

### SUMMARY

Techniques are disclosed for security monitoring using non-visible signals. Security monitoring using non-visible signals can be used to monitor human activity in areas of restricted access, such as in construction sites (e.g., for which walls and doors or fences might not be available to restrict access). The disclosed techniques can be used to determine whether a human has permission to access an area of a property (e.g., without requiring any identifiable information of the human).

An example security monitoring system can include an imaging device configured to generate images from detection of non-visible energy. An imaging device can include, for example, an infrared imaging device, an x-ray imaging device, an ultraviolet imaging device, or any other imaging device that generates images from electromagnetic energy outside of the human visible spectrum. In some examples, the imaging device can be configured to generate images from acoustic energy, such as ultrasonic energy. The imaging device can generate images when visible light is insufficient for generating visible light images, such as at outdoors at night, indoors when lighting is powered off or otherwise low, to reduce a risk that signals, e.g., visible light signals, are detected by a malicious actor, or a combination of these. The imaging device can be installed such that the field of view of the imaging device includes a restricted area of a property, an access portion for the restricted area, or another appropriate portion of the restricted area.

An example security monitoring environment can include wearable devices that are configured to emit and/or reflect signals of non-visible energy that are detectable by the imaging device. A human who is authorized to access the restricted area can wear a wearable device. For example, the wearable device can be attached to an accessory or clothing item worn by the human.

When a human accesses the area, the imaging device captures images of the human. A computing system obtains the images from the imaging device and detects the presence of the human in the images. In some examples, the detection of the human is a result of detecting movement in the images. In some examples, the detection of the human is a result of detecting non-visible light, such as when the images are captured in a low-light area. The computing system can then determine whether a non-visible energy signal is detected in at least some of the images in which the human is detected. In some examples, the computing system determines whether the human has permission to access the area in response to determining that a non-visible energy signal is detected in the images in which the human is detected.

In some examples, the computing system compares characteristics of the non-visible energy signal to stored characteristics of non-visible energy signals in order to determine whether the human is authorized to access the area. For example, the computing system can compare a pattern of the signal to stored patterns. In some examples, the computing system can compare a frequency and/or amplitude of the signals to stored frequencies and/or amplitudes.

In response to determining that characteristics of the non-visible energy signal match stored characteristics, the computing system can determine that the human has permission to access the area. In this way, the computing system can verify authorized access to the area, e.g., without obtaining any personal identifiable information of the human such as biometric information.

In response to determining that characteristics of the non-visible energy signal do not match stored characteristics, the computing system can determine that the human likely does not have permission to access the area. The computing system can perform one or more actions in response to determining that the human likely does not have permission to access the area. For example, the computing system can automatically initiate an alarm and/or send a notification to security personnel.

In general, one innovative aspect of the subject matter described in this specification can be embodied in methods that include the actions of obtaining, from an imaging device, a set of images of one or more physical locations surrounding or including an area of a property; detecting a human depicted in the set of images; determining whether the set of images includes an indication of a non-visible energy signal emitted by a wearable device worn by the human; and determining that the human has permission to access the area of the property in response to determining that the set of images includes the indication of the non-visible energy signal emitted by the wearable device worn by the human.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. In some implementations, the actions include obtaining, from the imaging device, a second set of images of the area of the property; detecting a second human in the second set of images; determining whether the second set of images includes an indication of a non-visible energy signal emitted by a second wearable device worn by the second human; and determining that the second human does not have permission to access the area of the property in response to determining that the set of images does not include the indication of the non-visible energy signal emitted by the wearable device worn by the human.

In some implementations, determining that the human has permission to access the area of the property includes: in response to determining that the set of images includes the indication of the non-visible energy signal emitted by the wearable device worn by the human, detecting a pattern of the non-visible energy signal; comparing the pattern of the non-visible energy signal to a set of stored patterns of non-visible energy signals; and determining that the human has permission to access the area of the property in response to (a) determining that the set of images includes the indication of the non-visible energy signal emitted by the wearable device worn by the human and (b) determining that the pattern of the non-visible energy signal matches a stored pattern of the set of stored patterns of non-visible energy signals.

In some implementations, the pattern of the non-visible energy signal includes a time-varying pattern detected over multiple images of the set of images.

In some implementations, the pattern of the non-visible energy signal includes a graphical pattern detected in an image of the set of images.

In some implementations, determining that the pattern of the non-visible energy signal matches the stored pattern includes determining that the pattern of the non-visible energy signal matches the stored pattern within a threshold similarity.

In some implementations, the set of stored patterns correspond to one or more character encoding systems.

In some implementations, the one or more character encoding systems includes at least one of Morse code, Baudot code, or tap code.

In some implementations, determining that the human has permission to access the area of the property includes: in response to determining that the set of images includes the indication of the non-visible energy signal emitted by the wearable device worn by the human, detecting a signal characteristic of the non-visible energy signal; comparing the signal characteristic of the non-visible energy signal to a set of stored signal characteristics of non-visible energy signals; and determining that the human has permission to access the area of the property in response to (a) determining that the set of images includes the indication of the non-visible energy signal emitted by the wearable device worn by the human and (b) determining that the signal characteristic of the non-visible energy signal matches a stored signal characteristic of the set of stored signal characteristics of non-visible energy signals.

In some implementations, the signal characteristic of the non-visible energy signal includes at least one of a frequency, an amplitude, a wavelength, a pulse width, and a pulse repetition frequency.

In some implementations, determining that the signal characteristic of the non-visible energy signal matches the stored signal characteristic includes determining that the signal characteristic of the non-visible energy signal matches the stored signal characteristic within a threshold similarity.

In some implementations, the area of the property includes an outdoor area; and the imaging device includes an outdoor imaging device that is physically located within a threshold distance of the outdoor area.

In some implementations, the non-visible energy signal includes an electromagnetic signal having a wavelength that is imperceptible to a human eye.

In some implementations, the non-visible energy signal includes radio energy, microwave energy, infrared energy, ultraviolet energy, x-ray energy, or gamma energy.

In some implementations, the non-visible energy signal includes acoustic energy.

In some implementations, the imaging device is configured to generate images from detection of non-visible energy.

Other implementations of any of the above aspects include corresponding systems, apparatus, and computer programs that are configured to perform the actions of the methods, encoded on computer storage devices. The present disclosure also provides a tangible, non-transitory computer-readable storage medium coupled to one or more processors and having instructions stored thereon which, when executed by the one or more processors, cause the one or more processors to perform operations in accordance with implementations of the methods provided herein. The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform those operations or actions. That one or more computer programs is configured to perform particular operations or actions means that the one or more programs include instructions that, when executed by data processing apparatus, cause the apparatus to perform those operations or actions. That special-purpose logic circuitry is configured to perform particular operations or actions means that the circuitry has electronic logic that performs those operations or actions.

The subject matter described in this specification can be implemented in various implementations and may result in one or more of the following advantages.

Security monitoring using non-visible signals can enable control of access to a site that might not have a physical access control barrier. For example, the disclosed techniques can allow for access control at a construction site that does not have an enclosed fence.

The disclosed techniques can be used to defend against spoofing. For example, an intruder at a work site may attempt to blend into surroundings by dressing like workers at the work site. Although the intruder may be able to see visual identifications such as identification cards and uniforms, the intruder will not be able to see, with their eyes, the non-visible signals that are used for access control at the work site. This reduces the likelihood the intruder will be able to spoof the non-visible signals, and increases the likelihood that the security system will detect the intruder.

Patterns of non-visible energy that are used for authentication can be varied over time. For example, a time-varying pattern emitted by a badge can change on an hourly, daily, or weekly basis, or according to another schedule or randomly. This can improve security and reduce the likelihood of spoofing. If an intruder attempts to enter a secure area with a badge emitting an old pattern, the system can determine that an intrusion is likely occurring.

Patterns of non-visible energy may be unique to enable discrimination amongst individuals or companies on a site. For example, the sequence of a pattern could be <company pattern><individual pattern>. The disclosed systems can interpret the pattern in order to verify authorization of personnel on site and to identify the personnel and/or the organization to which they belong.

Security monitoring using non-visible signals can improve security monitoring in low-light environments. Security monitoring using visible light cameras can be challenging at nighttime. The disclosed techniques use non-visible signals that can enable the detection of intruders at nighttime.

Security monitoring using non-visible signals can enhance control of secure areas while reducing privacy concerns. The disclosed techniques do not rely on biometric data or geotracking. Although the disclosed techniques can be integrated with mobile devices such as smart phones, the disclosed techniques can be implemented without the use of mobile devices.

Various embodiments of the disclosed techniques can be implemented without requiring personnel to carry or wear any energy source such as a battery. For example, patterns can be printed onto apparel worn by personnel, and illuminated with infrared energy. This reduces the need for personnel to carry a battery-powered device, to charge the device, and to turn on and off the device. This also reduces the likelihood of errors due to battery power running low.

Various embodiments of the disclosed techniques can be implemented by any camera with a nighttime IR mode, and without requiring a custom camera.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example environment for security monitoring using non-visible signals.

FIG. 2 shows an example monitoring system.

FIG. 3A shows an example of a camera passively capturing non-visible energy.

FIG. 3B shows an example of a camera actively emitting non-visible energy.

FIG. 4A shows an example of a badge emitting non-visible energy in a time-varying pattern.

FIG. 4B shows an example of a badge emitting or reflecting non-visible energy in a graphical pattern.

FIGS. 5A and 5B are flow diagrams of example processes for security monitoring using non-visible signals.

FIG. 6 is a diagram illustrating an example of a property monitoring system.

Like reference numbers and designations in the various drawings indicate like elements.

### DETAILED DESCRIPTION

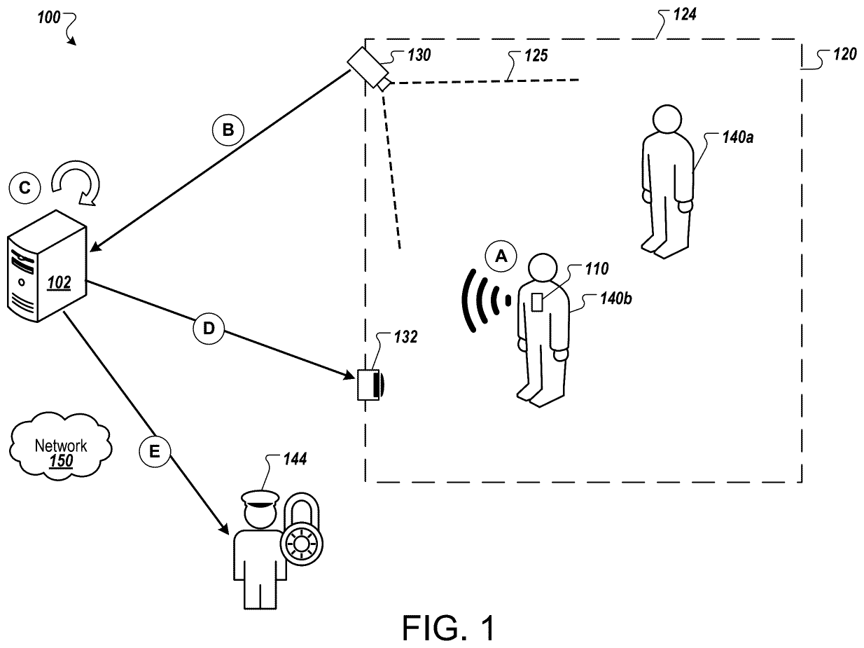

FIG. 1 shows an example environment 100 for security monitoring using non-visible signals. The environment 100 can be used to monitor the security of a property that includes a secure area 120.

The secure area is an area of the property within a security boundary 124. The security boundary 124 can be defined by rules that specify spatial coordinates of the boundary 124. In some examples, the security boundary 124 is defined by specified ranges to a fixed position. For example, the security boundary 124 can be defined by specified ranges to one or more sensors. In some examples, a distance from the security boundary 124 to a sensor corresponds to a detection range of the sensor. In some examples, some or all of the security boundary 124 is marked by visual indicator such as a flags, signs, fences, and/or chains. In some examples, some or all of the security boundary 124 is not visually marked.

The environment 100 includes at least one imaging device, such as a camera 130. The camera 130 has a field of view 125 that includes at least part of the secure area 120. In some examples, the camera 130 is an outdoor camera that is physically located within a threshold distance to the secure area 120.

The environment 100 includes an alarm 132. The alarm 132 can activate to indicate the presence of an unauthorized person in the secure area 120.

The camera 130 can generate images by detecting visible energy, non-visible energy, or a combination of both. In some examples, the camera 130 is a combination infrared and visible light camera. The camera 130 can use infrared fusion technology to generate blended visible and infrared images. Infrared fusion technology combines a video- rate infrared camera with a video-rate visible-light camera into a single instrument, so the scene can be viewed and recorded in both visible and infrared radiation. The visible image can be automatically corrected for parallax and sized to match the infrared image, so the infrared scene and visible scene can overlay each other. The camera 130 can output the visible image alone, infrared image alone, or a blended combination of the two. The modes can be switched manually or automatically.

The camera 130 can include an infrared cut filter that blocks infrared from entering the camera lens. In some examples, the camera 130 is operable in a night mode and in a day mode. In the day mode, the camera 130 can turn on the infrared cut filter. In the night mode, the camera 130 can turn off the infrared cut filter.

The environment 100 can include one or more additional security devices in addition to the camera 130. For example, the environment 100 can include one or more motion detectors, and/or one or more microphones.

The environment 100 includes a monitoring system 102. The monitoring system 102 can include one or more computers. The various components of the environment 100 can communicate over a network 150.

The property can be any residential, industrial, or commercial property such as a construction site, a school campus, a sports venue, an entertainment venue, a power plant, or a park. The secure area 120 can be indoor, outdoor, or a combination of indoor and outdoor. In some examples, access to the secure area 120 is controlled by one or more access points and/or access control devices. In some examples, the secure area 120 is marked by signs, postings, rope, tape, and/or fences.

The monitoring system 102 is an example of a system implemented as computer programs on one or more computers in one or more locations, in which the systems, components, and techniques described in this specification are implemented. The devices can include personal computers, mobile communication devices, and other devices that can send and receive data over the network 150. The network 150 can be a wired network, wireless network, or a combination of both. The network 150, such as a local area network (“LAN”), wide area network (“WAN”), the Internet, or a combination thereof, connects the camera 130, the alarm 132, and the monitoring system 102. The monitoring system 102 can use a single computer or multiple computers operating in conjunction with one another, including, for example, a set of remote computers deployed as a cloud computing service.

FIG. 1 illustrates various events, shown as stages (A) to (E), with each representing an operation in an example process for security monitoring using non-visible energy. Stages (A) to (E) can occur in the illustrated sequence, or in a sequence that is different from the illustrated sequence. For example, some of the stages can occur substantially concurrently.

At stage (A), a badge 110 emits or reflects non-visible energy. The badge 110 is a wearable device configured to be worn by a human. In some examples, the badge 110 includes a non-visible energy emitter. In some examples, the badge 110 includes a non-visible energy reflector. In some examples, the badge 110 might be a device that does not include computer circuitry.

In the example of FIG. 1, the badge 110 is worn by a human 140b. A human 140a is present in the secure area 120 and is not wearing a badge.

In some examples, the badge 110 includes a flashing non-visible energy beacon, such as a flashing infrared beacon. In some examples, the badge 110 includes a non-visible energy strobe light, such as an infrared strobe light. The badge 110 can emit directional energy, non-directional energy, or both.

The badge 110 can be affixed to clothing or accessories worn by the human 140b. For example, the badge 110 can be sewn, e.g., as an active device, or ironed, e.g., as a passive device, onto a garment worn by the human 140b.

In some examples, the badge 110 is removably attached to clothing or accessories. For example, the badge 110 can be clipped, pinned, or magnetically attached to a garment, accessory, or protective item. The badge 110 can be attached to, for example, a belt, nametag, lanyard, shoe, glove, or helmet.

In some examples, the badge 110 is printed onto a garment worn by the human 140b. The badge 110 can be printed with ink that is not visible to the human eye, such as ultraviolet ink or infrared ink. In some examples, the badge 110 can include a combination of visible and not visible ink. Patterns for the visible and not visible ink can be the same. Patterns for the visible and not visible ink can be different.

Infrared inks are completely invisible to the human eye yet can be detected using an imaging device which receives infrared energy that reflects when contacting the infrared ink. The infrared ink can reflect the infrared energy when the ink is within a predetermined range of an infrared source. The infrared source can be an infrared illuminator that is integrated with the imaging device or separate from the imaging device. In some examples, the infrared source is ambient infrared energy. Infrared inks do not fluoresce in the visible range, cannot be seen with ultraviolet light, and cannot be seen by the human eye alone.

In some examples, the badge 110 is printed onto a garment or another wearable object with visible infrared ink. Visible infrared ink can be printed with ink that is the same color as a background color of the wearable object, e.g., black ink. Under normal light conditions, black ink can hide an image, e.g., when the background onto which the black ink is also black. When illuminated with infrared light, the black ink disappears, and an image is discernible.

In some examples, the badge 110 is printed onto a garment with invisible infrared ink. Invisible infrared ink is printed with transparent ink. Under normal light conditions, the printed pattern is invisible to the human eye. When illuminated with infrared light, the printed pattern is discernable.

In some examples, the badge 110 emits non-visible energy continuously. For example, the badge 110 can emit non-visible energy when the human 140b is in the secure area 120 and when the human 140b is outside of the secure area 120.

In some examples, the badge 110 emits non-visible energy on demand and/or in response to a trigger. For example, the badge 110 can emit non-visible energy when the human 140b is in the secure area 120 and not when the human 140b is outside of the secure area 120. The non-visible energy signal emission can be triggered when the badge 110 enters the secure area 120 and/or when the badge 110 is located inside the secure area 120.

In some examples, the badge 110 is triggered to emit non-visible energy when the badge 110 is within a threshold proximity to the boundary 124 or when the badge 110 is within a threshold proximity to the camera 130. For example, the badge 110 can include a near field communication device that is configured to communicate with the camera 130 and/or with one or more transmitters or receivers located at the boundary 124. When the badge 110 is within a threshold proximity to the camera 130 or the boundary 124, as determined through near field communication, the badge 110 can initiate emitting non-visible energy. When the badge 110 is no longer within the threshold proximity, the badge 110 can cease emitting the non-visible energy.

In some examples, the badge 110 emits non-visible energy according to a pattern. The pattern can repeat at designated intervals. In some examples, the pattern repeats at intervals of approximately ten seconds (e.g., four seconds or more, six seconds or more, eight seconds or more). In some examples, the pattern repeats at intervals of approximately twenty seconds (e.g., thirty seconds or less, twenty-five seconds or less, twenty-two seconds or less).

At stage (B), the monitoring system 102 obtains image data generated by the camera 130. The camera 130 is configured to generate images from detection of non-visible energy. The camera 130 can transmit the images to the monitoring system 102 over the network 150.

The non-visible energy signal can be any appropriate type of non-visible energy signal. In some examples, the non-visible energy signal is an electromagnetic signal having a wavelength that is imperceptible to a human eye. In some examples, the non-visible energy signal includes radio energy, microwave energy, infrared energy, ultraviolet energy, x-ray energy, gamma energy, or any combination of these. In these examples, the environment 100 can include another type of sensor, e.g., instead of or included in the camera 130, that detects the corresponding type of non-visible energy signal.

The human eye is capable of seeing visible electromagnetic energy at wavelengths from about 400 nanometers (nm) to about 700 nm. Electromagnetic energy outside of the visible range is “non-visible” electromagnetic energy. The human eye cannot see below 400 nm or above 700 nm. Below 400 nm is the ultraviolet range and above 700 nm is the infrared range.

The infrared region of the electromagnetic spectrum includes near infrared (NIR, 0.75-1.1 micron (μm) range), short-wavelength infrared (SWIR, 1.1-2.5 μm range), mid-wavelength infrared (M WIR, 3-5 μm range) and long-wavelength infrared (LWIR, 7.5-14 μm range).

Infrared energy can be radiated or reflected by the badge 110. Several factors affect the discernability of the badge 110 in images generated by the camera 130. Factors include badge size, badge surface finish, environmental temperature, background energy, atmospheric conditions, or a combination of these. Factors can also include the intensity of energy emitted by the badge 110.

In some examples, the non-visible energy signal includes acoustic energy. For example, the non-visible energy signal can include acoustic energy at frequencies that are above or below human hearing range. In some examples, the non-visible energy signal includes ultrasonic signals.

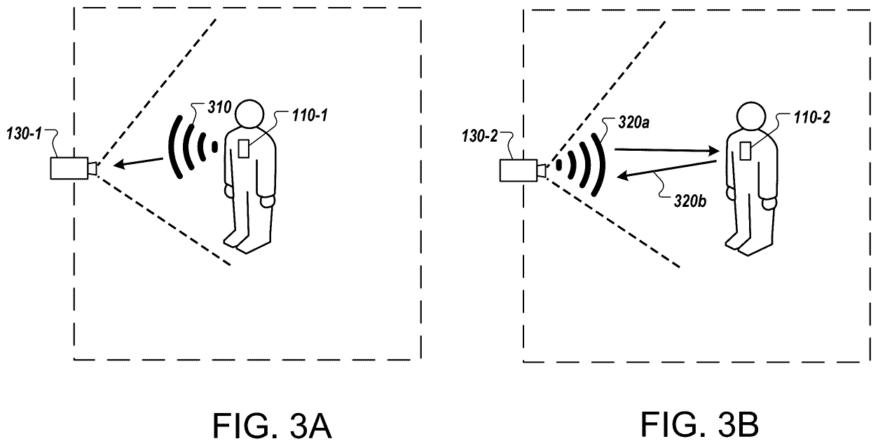

The non-visible energy detection performed by the camera 130 can be passive, active, or a combination of passive and active. Passive and active energy detection are described in greater detail with reference to FIGS. 3A and 3B, respectively.

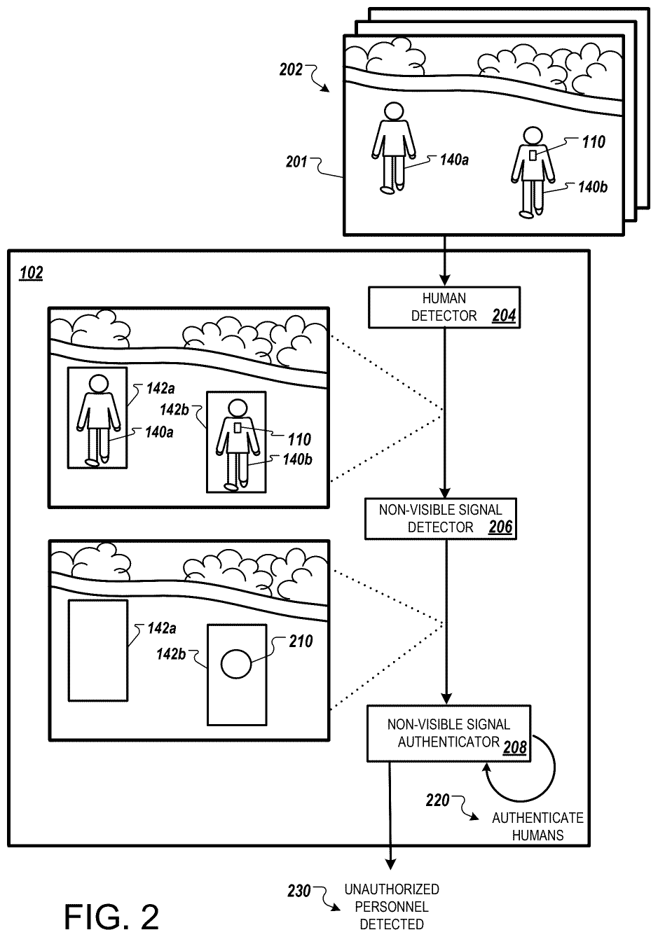

At stage (C), the monitoring system 102 uses the image data to determine whether any detected humans are authorized to be in the secure area 120. Referring to FIG. 2, the monitoring system 102 can include several different functional components, including a human detector 204, a non-visible signal detector 206, and a non-visible signal authenticator 208. The human detector 204, the non-visible signal detector 206, the non-visible signal authenticator 208, or a combination of these, can include one or more data processing apparatuses, can be implemented in code, or a combination of both. For instance, each of the human detector 204, the non-visible signal detector 206, and the non-visible signal authenticator 208 can include one or more data processors and instructions that cause the one or more data processors to perform the operations discussed herein.

The various functional components of the human detector 204, the non-visible signal detector 206, and the non-visible signal authenticator 208 can be installed on one or more computers as separate functional components or as different modules of a same functional component. For example, the components of the human detector 204, the non-visible signal detector 206, and the non-visible signal authenticator 208 of the monitoring system 102 can be implemented as computer programs installed on one or more computers in one or more locations that are coupled to each through a network. In cloud-based systems for example, these components can be implemented by individual computing nodes of a distributed computing system.

The monitoring system 102 receives, as input, a set of one or more images 202 generated by the camera 130. The set of images 202 include image 201. The image 201 shows humans 140a, 140b.

The set of images 202 can include images generated from visible light, non-visible light, or a combination of both. In some examples, the set of images 202 includes images generated from visible light. In response to the monitoring system 102 detecting an infrared signal, the monitoring system 102 can send an instruction to the camera 130 to switch from a visible light mode to a non-visible light mode, e.g., if the camera 130 was not already in the non-visible light mode. In some examples, the visible light mode is a “daytime” mode, and the non-visible light mode is a “nighttime” mode.

The set of images 202 can include a video clip of multiple video images. The video clip can include images captured over a period of time (e.g., thirty seconds, sixty seconds, ninety seconds).

The length of video clips received and analyzed by the monitoring system 102 can be fixed or variable. In some examples, the camera 130 selects a video clip to send to the monitoring system 102. The camera 130 can select the length of the video clip based on factors such as a speed of movement of humans within the field of view 125. For example, when the camera captures images of a person standing still, the camera may select a longer video clip. When the camera captures images of a person walking or running, the camera may select a shorter video clip to send to the monitoring system 102, since the person may be in the field of view for a shorter amount of time.

The human detector 204 detects the presence of humans in the set of images 202. In some examples, the human detector 204 includes a motion detector and an object classifier. The human detector 204 can use the motion detector to detect motion within the set of images 202, and can use the object classifier to determine whether or not the motion is likely caused by a human. In some examples, the human detector 204 performs motion detection and human detection simultaneously.

In some examples, the human detector 204 makes a determination that the moving object is a human or is not a human. In some examples, the human detector 204 classifies moving objects according to object type. For example, the human detector 204 can classify and label humans, animals, vehicles, and/or other object types depicted in the set of images 202.

In the example of FIG. 2, the human detector 204 detects two humans 140a, 140b in the set of images 202. The human detector 204 can generate bounding boxes 142a, 142b around the humans 140a, 140b, respectively. The human detector 204 outputs an indication of the human detections to the non-visible signal detector 206.

The non-visible signal detector 206 detects a non-visible energy signal in the set of images 202. In some examples, the non-visible energy signal is emitted by an object within the field of view 125 of the camera 130, such as the badge 110. In some examples, the non-visible energy signal is emitted by an infrared illuminator and is reflected by the badge 110.

In the example of FIG. 2, the non-visible signal detector 206 detects an indication of a non-visible energy signal 210 in the set of images 202. The non-visible energy signal 210 is emitted by the badge 110 worn by the human 140b. The non-visible energy signal 210 can be indicated by a region of an image that is at a higher intensity than the background. For example, the non-visible energy signal may appear as a bright spot in an image.

In the example of FIG. 2, the non-visible signal detector 206 detects the non-visible energy signal 210 inside the bounding box 142b for the human 140b. The non-visible signal detector 206 does not detect a non-visible energy signal inside the bounding box 142a for the human 140a.

The non-visible signal authenticator 208 authenticates 220 humans detected in the set of images 202. For example, the non-visible signal authenticator 208 can determine that the human 140b is wearing the badge 110 that is emitting the non-visible energy signal 210, and therefore that the human 140b is authorized to be in the secure area 120. The non-visible signal authenticator 208 can determine that the human 140a is not wearing a badge that is emitting a non-visible energy signal, and therefore that the human 140a is not authorized to be in the secure area 120.

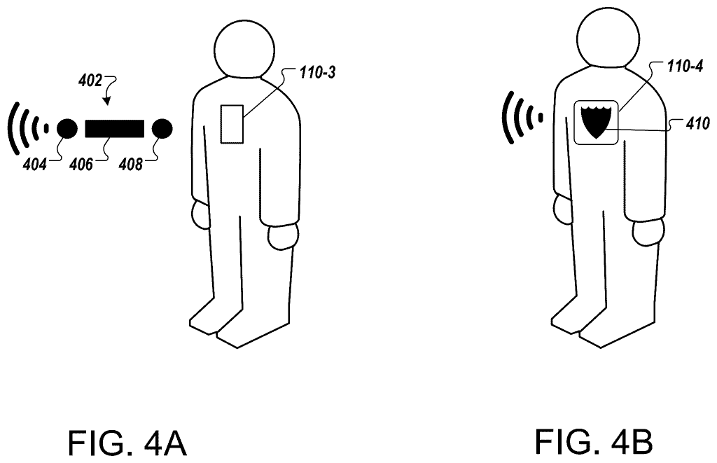

In some examples, upon detecting the non-visible energy signal 210, the non-visible signal authenticator 208 performs additional authentication steps in order to determine whether the human 140b is authorized to be in the secure area 120. For example, the non- visible signal authenticator 208 can compare a time-varying pattern, a graphical pattern, or a combination of both, of the non-visible energy signal 210 to stored patterns. Example patterns are described in greater detail with reference to FIGS. 4A and 4B.

In some examples, the non-visible signal authenticator 208 compares characteristics of the non-visible energy signal 210 to stored characteristics. Characteristics of the non-visible energy signal can include, for example, a frequency, an amplitude, a wavelength, a pulse width, a pulse repetition frequency, or a combination of these, of the signal. The non-visible signal authenticator 208 can determine that a signal characteristic of the non-visible energy signal 210 matches a stored signal characteristic. In response to determining that the signal characteristic matches the stored signal characteristic within a threshold similarity, the non-visible signal authenticator can determine that the human 140b likely has permission to access the secure area 120. In response to determining that the signal characteristic does not match the stored signal characteristic within the threshold similarity, the non-visible signal authenticator can determine that the human 140b likely does not have permission to access the secure area 120.

In some examples, the non-visible signal authenticator identifies and/or classifies the human 140b based on the non-visible energy signal 210. For example, the non-visible energy signal 210 can have a pattern that is unique to the human 140b. The pattern can indicate, for example, the human's name or employee identification number. In some examples, the non-visible energy signal 210 has a pattern that is unique to the human's job title or organizational role. In some examples, the non-visible energy signal 210 has a pattern that is unique to the human's security clearance level or organizational department or both.

For example, a site may have personnel with security levels 1, 2, and 3, with 1 being the lowest security level, e.g., least secure, and 3 being the highest security level, e.g., most secure. A particular secure area may permit people with level 2 and higher. The non-visible signal authenticator 208 can determine that a non-visible energy signal detected from a wearable device worn by a person detected in the area has a pattern that corresponds with security level 3, and can determine that the person is authorized to be in the secure area. The non-visible signal authenticator 208 can determine that a non-visible energy signal detected from a wearable device worn by a person detected in the area has a pattern that corresponds with security level 1, and can determine that the person is not authorized to be in the secure area.

In the example of FIG. 2, the non-visible signal authenticator 208 determines that the human 140a is likely not authorized to be in the secure area 120. In response, the non-visible signal authenticator 208 outputs an indication of unauthorized personnel detected 230.

In response to determining that one or more personnel are likely unauthorized, the monitoring system 102 can perform one or more actions. Actions can include labeling the human 140a in the set of images 202 as “unauthorized.” Actions can include outputting an alert, activating an alarm, transmitting a notification, or any combination of these. Additional actions are described in greater detail with reference to FIG. 1, stages (D) and (E).

FIG. 3A shows an example of a camera 130-1 passively capturing non-visible energy. In some examples, the camera 130-1 can be a passive imaging device that generates images from infrared energy. The badge 110-1 can emit non-visible energy signals 310, such as infrared energy signals.

The badge 110-1 can emit non-visible energy signals continuously, intermittently, or repeatedly. In some examples, the badge 110-1 emits non-visible energy signals on demand. For example, the badge 110-1 can emit non-visible energy in response to receiving a trigger signal from the camera 130-1 or from a transmitter in or near the secure area 120.

In some examples, the badge 110-1 receives a request signal. In response, the badge 110-1 emits a response signal that can be captured by the camera 130-1. In some examples, the request signal can identify a type of response. For instance, when the request signal is a mirror request signal, the response signal mirrors the request signal. For example, the badge 110-1 can receive a request signal that includes three short pulses, and in response can output a response signal that includes three short pulses. The non-visible signal authenticator 208 can compare the received response signal to an expected response signal. For example, the non-visible signal authenticator 208 can determine whether the response signal mirrored the request signal in order to authenticate the badge 110-1.

FIG. 3B shows an example of a camera 130-2 actively emitting non-visible energy 320a. The emitted non-visible energy 320a reflects off of the badge 110-2 as reflected non-visible energy 320b. The reflected energy 320b is captured by the camera 130-2.

In some examples, an infrared illuminator illuminates at least part of the secure area 120. In some examples, the infrared illuminator is physically integrated with the camera 130-2. In some examples, the infrared illuminator is separate from the camera 130.

The infrared illuminator can function similarly to a spotlight or a flashlight; instead of projecting visible light, the infrared illuminator projects infrared light. The infrared light reflects off of objects such as the badge 110-2. The camera 130-2 can generate images from the reflected infrared energy. The images can depict the badge 110-2 and/or any pattern reflected by the badge 110-2.

FIGS. 4A and 4B show examples of badges emitting non-visible energy in time-varying patterns and graphical patterns, respectively.

FIG. 4A shows an example of a badge 110-3 emitting non-visible energy in a time-varying pattern 402. The time-varying pattern 402 includes a short pulse 404, a long pulse 406, and a short pulse 408.

In some examples, the time-varying pattern 402 represents characters such as alphanumeric characters. The characters can be encoded according to a character encoding system such as Morse code. In the example of FIG. 4A, the time-varying pattern 402 represents the letter “R” in Morse code.

The badge can emit light that spells out an identifier. The identifier can include any number of digits representing letters, numbers, symbols, and/or punctuation. For example, the identifier for a person or group of persons can include three, four, or five digits. In some examples, the identifier includes digits corresponding to identifying information such as initials of the person (e.g., A-P-D). In some examples, the identifier includes digits of an employee identifier (e.g., 1-5-7-2-4). In some examples, the identifier includes digits corresponding to an organizational role or department of the person (e.g., S-E-C for security; E-N-G for engineer).

In some examples, the badge 110-3 emits non-visible energy in a repeating pattern. For example, the badge 110-3 can emit the short pulse 404, the long pulse 406, and the short pulse 408, and after a duration of time, repeat emitting the short pulse 404, the long pulse 406, and the short pulse 408.

In some examples, the repeating pattern includes multiple digits such as alphanumeric digits. For example, the badge 110-3 can emit the pattern 402, representing the character “R,” followed by a time interval during which the badge 110-3 does not emit non-visible energy, followed by emitting another pattern that represents a different character.

The monitoring system 102 can detect the pattern of the non-visible energy signal over multiple images of the set of images 202 captured by the camera 130. For example, the set of images 202 can include a first series of images in which the badge 110-3 emits non-visible energy. The first series of images can be captured by the camera 130 over a time duration that corresponds to a pulse duration of the pulse 404.

The set of images 202 can include a second series of images in which the badge 110-3 does not emit non-visible energy. The second series of images can be captured by the camera 130 over a time duration that corresponds to a time between an end of the pulse 404 and a beginning of the pulse 406.

The set of images 202 can include a third series of images in which the badge 110-3 emits non-visible energy. The third series of images can be captured by the camera 130 over a time duration that corresponds to a pulse duration of the pulse 406.

The set of images 202 can include a fourth series of images in which the badge 110-3 does not emit non-visible energy. The fourth series of images can be captured by the camera 130 over a time duration that corresponds to a time between an end of the pulse 406 and a beginning of the pulse 408.

The set of images 202 can include a fifth series of images in which the badge 110-3 emits non-visible energy. The third series of images can be captured by the camera 130 over a time duration that corresponds to a pulse duration of the pulse 408.

The non-visible signal detector 206 can evaluate the set of images 202 in order to detect the time-varying pattern 402 in the set of images 202. For example, the non-visible signal detector 206 can determine pulse durations of the pulses 404, 406, 408, and time intervals between the pulses 404, 406, and between the pulses 406, 408.

In some examples, the non-visible signal detector 206 evaluates the set of images 202 by monitoring for flashes of non-visible energy in the set of images 202. A flash of non-visible energy can be indicated by an appearance of a bright spot in the image, where previously the bright spot did not exist, e.g., in one or more preceding images. The non-visible signal detector 206 can detect a flash of non-visible energy based on identifying occurrences of rapid changes in brightness in sequential images. For example, a region of the set of images can change over time from lower brightness, to higher brightness, to lower brightness. The non-visible signal detector 206 can determine a pulse duration of the flash of non-visible energy based on a number of consecutive images in which the region has the higher brightness.

When the non-visible signal detector 206 detects a flash of non-visible energy, the non-visible signal detector 206 can continue to monitor areas of the images at or near the location of the bright spot for additional flashes of non-visible energy. In some examples, the non-visible signal detector 206 generates a bounding box around a detected flash and can track movement of the flashing non-visible energy over time, e.g., using data for the bounding box. In this way, the non-visible signal detector 206 can track motion of a non-visible energy-emitting badge across the field of view of the camera 130 over time.

A fter detecting at least one flash of non-visible energy, the non-visible signal detector 206 can determine characteristics the time-varying pattern 402 of the non-visible energy. For example, the monitoring system 102 can evaluate the set of images 202 in order to determine a pulse length of each pulse, a time interval between pulses, a time duration from a start of the pattern 402 to an end of the pattern 402, or any combination of these.

In some examples, the amplitude of the non-visible energy can change over time, resulting in varying brightness depicted in the set of images 202 over time. The non-visible signal detector 206 can evaluate the set of images to identify patterns in amplitude variations over time.

In some examples, the non-visible signal authenticator 208 performs authentication 220 by comparing the time-varying pattern 402 to a set of time-varying patterns stored in a database. The non-visible signal authenticator 208 can determine whether the time-varying pattern 402 matches a stored pattern within a threshold similarity.

In some examples, the set of stored patterns correspond to one or more character encoding systems. The character encoding systems can include, for example, M orse code, Baudot code, or tap code. The monitoring system 102 can decode the time-varying pattern 402 using a character encoding system. For example, the monitoring system 102 can decode the pattern 402 to determine that the pattern 402 represents the letter “R” in Morse code.

In some examples, the monitoring system 102 includes one or more artificial intelligence models that are trained to decode time-varying patterns of non-visible light. For example, a machine learning model can be trained using training images that depict non-visible energy signals flashing according to various patterns. The machine learning model can be trained to identify characters represented by the patterns of non-visible energy signals, such as alphanumeric characters.

In some examples, after the time-varying pattern 402 is decoded, the non-visible signal authenticator 208 can compare the decoded pattern to stored patterns. For example, the monitoring system 102 can decode a sequence of pulses emitted by the badge 110, in order to determine that the sequence of pulses represents the letters “R,” “A,” “D.” The non-visible signal authenticator 208 can compare the decoded pattern to stored patterns in a database of organizational departments associated with the worksite. The non-visible signal authenticator 208 can determine that the code R-A-D corresponds to the radiological controls department, and therefore the person wearing the badge 110-3 is likely a member of the radiological controls department.

In some examples, the monitoring system 102 transcribes the decoded pattern for presentation to a user. For example, the monitoring system can decode a time-varying pattern in order to determine that the time-varying pattern represents the letters R-A-D. The monitoring system 102 can label the bounding box around the detected flash with the letters R-A-D. The set of images 202, or one or more selected images from the set of images 202, can be presented through a user interface that shows the location of the human annotated with the label R-A-D.

In some examples, patterns emitted by the badge 110-3 can change over time. For example, a pattern can change at designated intervals (e.g., hourly, daily, weekly). In some examples, the badge 110-3 is programmed to emit different patterns at different times (e.g., different patterns for different days of the week).

In some examples, the badge 110-3 receives a new pattern assignment at designated intervals. For example, the human can scan the badge 110-3 at a scanner when arriving to the worksite at the beginning of a daily shift. When the badge 110-3 scans at the scanner, the badge 110-3 can receive an assignment of an updated pattern of non-visible energy. The badge 110-3 emits the pattern, and the camera 130 captures images of the badge 110-3 emitting the updated pattern. The monitoring system 102 can detect and/or decode the pattern and compare the pattern to the assigned daily pattern to determine whether the human is authorized to be in the secure area 120.

In some examples, the badge 110-3 can emit a distress code through non-visible energy. For example, the badge 110-3 can be in electronic communication with a device such as a smart phone. The human can use an application on the smart phone to indicate distress. The smart phone can transmit an instruction to the badge 110 that causes the badge 110 to emit the non-visible energy in distress pattern (e.g., S-O-S). In some examples, the badge 110 can include a button or switch that, when operated by human, causes the badge 110 to emit the non-visible energy signal in the distress pattern.

In some examples, the distress code indicates a type of distress (e.g., security alert, medical emergency, fire). The monitoring system 102 can decode the non-visible energy pattern and determine that the human 140b is likely in distress and the corresponding type of distress. In response, the monitoring system 102 can perform actions, e.g., specific to the type of distress, such as transmitting a notification to appropriate personnel such as security personnel, medical personnel, or firefighters. This can enable monitoring systems 102 to detect and respond to emergencies using images captured by imaging devices at night or at another appropriate time when non-visible energy is detectable.

FIG. 4B shows an example of a badge 110-4 emitting or reflecting non-visible energy in a graphical pattern 410.

In some examples, the graphical pattern 410 is printed, sewn, or otherwise affixed to a garment. The graphical pattern 410 is invisible to human eyes, and becomes visible to the camera 130 when illuminated with non-visible energy. For example, as described with reference to FIG. 1, the graphical pattern 410 can be printed in infrared ink or ultraviolet ink.

In some examples, the badge 110-4 includes an electronic device that is affixed to the garment and emits non-visible energy according to the graphical pattern 410. For example, the badge can include an array of infrared light emitting diodes (LEDs). The badge 110-4 can be programmable to illuminate selected LEDs of the array in order to present the pattern 410. For example, the badge 110-4 can illuminate LEDs in a circular pattern or square pattern. The infrared light emitted by the selected LEDs are invisible to the human eye, and are visible to the camera 130.

In some examples, the graphical pattern 410 includes characters such as alphanumeric characters. In some examples, the graphical pattern 410 includes symbols, icons, pictures, and/or abstract patterns. In some cases, the graphical pattern 410 spells out an identifier. The identifier can include any number of digits representing letters, numbers, symbols, and/or punctuation.

The badge 110-4 can reflect the non-visible energy such that the graphical pattern is discernible in the set of images 202 captured by the camera 130. The non-visible signal detector 206 can evaluate the set of images 202 in order to detect the graphical pattern 410 in the set of images 202.

The non-visible signal detector 206 can determine characteristics of the graphical pattern 410 of the non-visible energy. For example, the non-visible signal detector 206 can evaluate the set of images 202 in order to determine a size of the pattern 410, a shape of the pattern 410, or both. In some examples, the non-visible signal detector 206 can identify and/or interpret alphanumeric characters within the pattern 410.

In some examples, the monitoring system 102 includes one or more machine learning models that are trained to decode graphical patterns of non-visible light. For example, the machine learning models can be trained using training images that depict non-visible energy signals reflected or emitted in various graphical patterns. The machine learning models can be trained to identify characters represented by the patterns of non-visible energy signals, such as alphanumeric characters.

The non-visible patterns can be used to train the human detector 204. In a scenario where it all personnel within an area wear a badge having a non-visible pattern, the location of all detected non-visible patterns within an image will each correspond to a human. Therefore, images captured of the personnel can be used as labeled training data to train machine learning models implemented by the human detector 204.

In some examples, the non-visible signal authenticator 208 compares the graphical pattern 410 to a set of graphical patterns stored in a database. The non-visible signal authenticator 208 can determine whether the graphical pattern 410 matches a stored pattern within a threshold similarity.

In some examples, patterns reflected by the badge 110-4 can change over time. For an example badge that includes an array of infrared LEDs, a pattern can change at designated intervals (e.g., hourly, daily, weekly). In some examples, the badge 110-4 is programmed to display patterns at different times (e.g., different patterns for different days of the week).

In some examples, the badge 110-4 receives a new pattern assignment at designated intervals. For example, the human can scan the badge 110-4 at a scanner when arriving to the worksite at the beginning of a daily shift. When the badge 110-4 scans at the scanner, the badge 110-4 can receive an assignment of a new pattern of non-visible energy. The badge 110-4 can emit the updated pattern by illuminating selected LEDs, and the camera 130 can capture images of the badge 110-4 emitting the updated pattern. The monitoring system 102 can detect the pattern and compare the pattern to the assigned daily pattern to determine whether the human is authorized to be in the secure area 120.

Referring back to FIG. 1, At stage (D), the monitoring system 102 performs an action of activating an alarm 132 in response to determining that an unauthorized person is detected in the secure area 120. The alarm can be an audible or visible alarm. In some examples, the alarm 132 is activated in or near the secure area 120, or a combination of both. In some examples, the alarm 132 is activated at a control station, security station, monitoring station, or a combination of these.

In some examples, the alarm 132 is a silent alarm. In some examples, the alarm 132 is a non-visible alarm. In some examples, the alarm 132 emits the same type of non-visible energy that is emitted from and/or reflected by the badge 110.

At stage (E), the monitoring system 102 performs an action of notifying security personnel 144 of a possible intruder. In some examples, the monitoring system 102 transmits a notification to computing devices associated with security personnel, indicating that the human 140a is a possible intruder.

In some examples, the monitoring system 102 sends images captured by the camera 130 to the security personnel 144. For example, in response to determining that the human 140a is not allowed to access the secure area 120, the monitoring system 102 can select one or more images to send to the security personnel 144. The monitoring system 102 can select images that depict the human 140a.

In some examples, the monitoring system 102 generates bounding boxes around the humans 140a, 140b in the set of images. The monitoring system 102 can label the bounding boxes according to the classifications of the humans 140a, 140b made by the non-visible signal authenticator 208. For example, the monitoring system 102 can label a bounding box around the human 140a “unauthorized.” The monitoring system 102 can label the bounding box around the human 140b “authorized.”

In some examples, the monitoring system 102 labels the bounding boxes with information determined about the human using the detected non-visible energy. For example, the monitoring system 102 can label a bounding box with a name of an individual, an organizational role of an individual, a title of an individual, an organizational department of an individual, or any combination of these.

In some examples, the monitoring system 102 can perform an action of sending an instruction to adjust security control devices. For example, the monitoring system 102 can send an instruction to automatically lock or unlock a door or gate of the secure area 120. For example, in response to determining that the human 140b has permission to access the secure area 120, the monitoring system 102 can transmit a signal to unlock a gate to the secure area 120 when the human 140b approaches the secure area 120. The door or gate can provide access to the secure area 120, access to another area, e.g., adjacent to or within the secure area 120, or a combination of both.

In some examples, the monitoring system 102 sends an instruction to automatically open or shut, or maintain a current position of, a door or gate of the secure area 120. For example, in response to determining that the human 140a does not have permission to access the secure area 120, the monitoring system 102 can transmit a signal to shut or otherwise maintain shut one or more doors in order to prevent the human 140a in order to prevent the human 140a from departing from the secure area 120 while security personnel 144 are notified of the likely intrusion.

In an example scenario, workers at a work site wear orange shirts. The workers' orange shirts have a pattern printed in infrared ink. An intruder attempts to blend in at the work site by wearing an orange shirt without the infrared pattern. The camera illuminates an area within the work site with infrared light. The infrared light reflects off of the printed patterns on the shirts of the workers within the area, such that the printed patterns are discernable in the images generated by the camera. The images generated the camera do not show any pattern on the intruder's shirt. Therefore, the monitoring system 102 can determine that the intruder is not authorized to be in the area and can perform actions in response to detecting the intrusion.

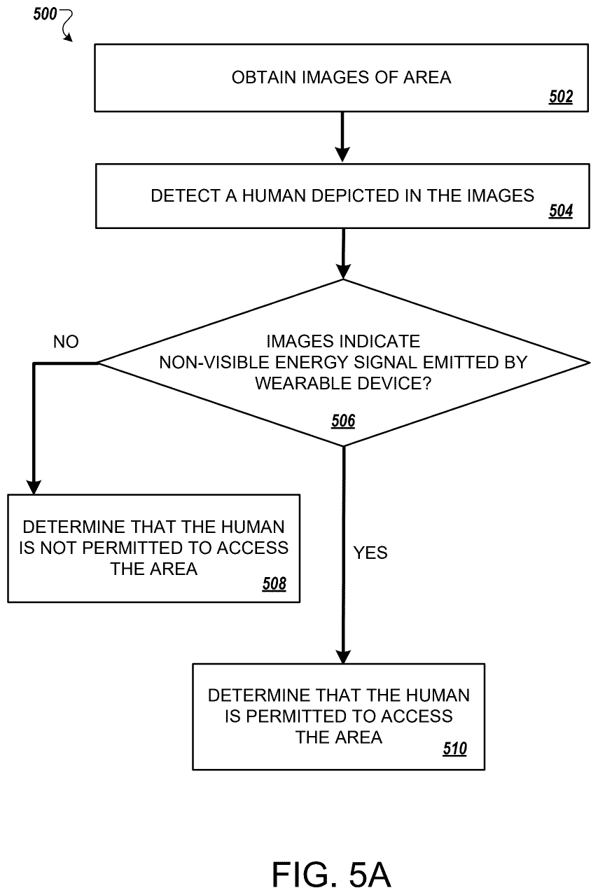

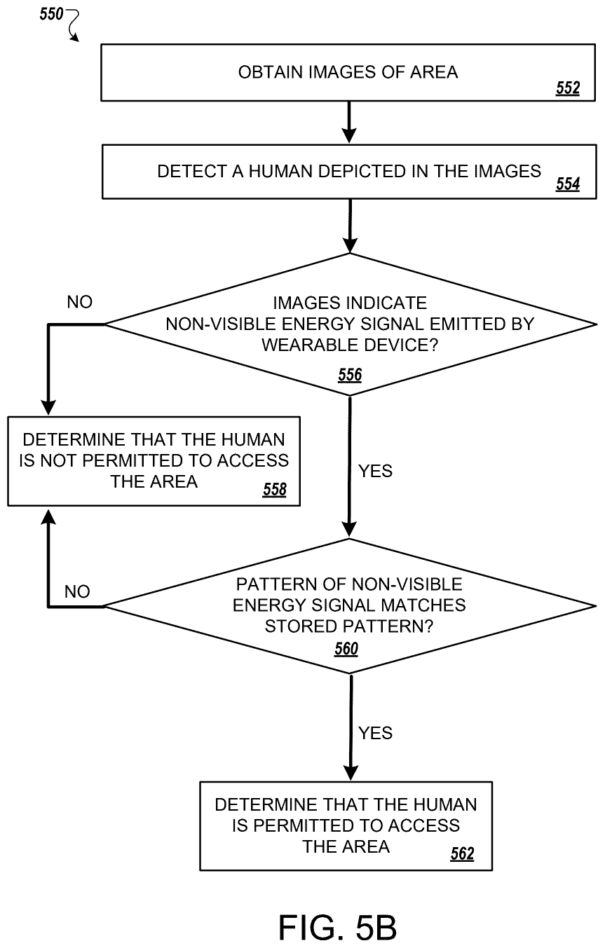

FIG. 5A is a flow diagram of a process 500 for security monitoring using non-visible signals. For example, the process 500 can be used by the monitoring system 102 and/or the camera 130 from the environment 100. In general, the process 500 includes determining whether or not a human has access to a secure area based on whether or not the human is wearing a wearable device that emits or reflects a non-visible signal.

The process 500 includes obtaining images of an area of a property (502). In some examples, the monitoring system 102 obtains a set of images of one or more physical locations surround or including an area of the property. For example, the monitoring system 102 can obtain a set of images including the image 201.

The process 500 includes detecting a human depicted in the images (504). For example, the monitoring system 102 can detect the human 140a and the human 140b in the image 201.

The process 500 includes determining whether the images include an indication of a non-visible energy signal emitted by a wearable device worn by the human (506). For example, the monitoring system 102 can determine that the image 201 includes an indication of a non-visible energy signal emitted by the badge 110 worn by the human 140b. The monitoring system 102 can determine that the image 201 does not include an indication of a non-visible energy signal emitted by a wearable device worn by the human 140a.

The process 500 includes, in response to determining that the images do not include an indication of a non-visible energy signal emitted by a wearable device worn by a detected human, determining that the human does not have permission to access the area (508). For example, the monitoring system 102 can determine that the human 140a likely does not have permission to access the secure area 120 in response to determining that the set of images does not include an indication of a non-visible energy signal emitted by a wearable device worn by the human 140a.

The process 500 includes, in response to determining that the images include an indication of a non-visible energy signal emitted by a wearable device worn by a detected human, determining that the human has permission to access the area (510). For example, the monitoring system 102 can determine that the human 140b has permission to access the secure area 120 in response to determining that the set of images includes the indication of a non-visible energy signal emitted by the wearable device worn by the human 140b.

The order of operations in the process 500 described above is illustrative only, and can be performed in different orders. For example, the monitoring system 102 can detect the non-visible energy signal in the set of images at the same time as, or before, the monitoring system 102 detects the human depicted in the images. In some examples, some steps can be performed by the monitoring system 102, and other steps can be performed by the camera 130.

In some implementations, the process 500 can include additional operations, fewer operations, or some of the operations can be divided into multiple operations. For example, in some cases the monitoring system can detect multiple humans in a set of images, and evaluate each detected human simultaneously to determine whether the set of images includes an indication of a non-visible energy signal emitted by a wearable device worn by the human. In some cases, the monitoring system can detect multiple humans in a set of images, and evaluate each detected human sequentially to determine whether the set of images includes an indication of a non-visible energy signal emitted by a wearable device worn by the human.

FIG. 5B is a flow diagram of a process 550 for security monitoring using non-visible signals. For example, the process 550 can be used by the monitoring system 102 and/or the camera 130 from the environment 100. In general, the process 550 includes determining whether or not a human has access to a secure area based on comparing a non-visible signal emitted by a wearable device worn by the human matches a pattern of a stored non-visible signal.

The process 550 includes obtaining images of an area of a property (552). In some examples, the monitoring system 102 obtains a set of images of one or more physical locations surround or including an area of the property. For example, the monitoring system 102 can obtain a set of images including the image 201.

The process 550 includes detecting a human depicted in the images (554). For example, the monitoring system 102 can detect the human 140a and the human 140b in the image 201.

The process 550 includes determining whether the images include an indication of a non-visible energy signal emitted by a wearable device worn by the human (556). For example, the monitoring system 102 can determine that the image 201 includes an indication of a non-visible energy signal emitted by the badge 110 worn by the human 140b. The monitoring system 102 can determine that the image 201 does not include an indication of a non-visible energy signal emitted by a wearable device worn by the human 140a.

The process 550 includes, in response to determining that the images do not include an indication of a non-visible energy signal emitted by a wearable device worn by a detected human, determining that the human does not have permission to access the area (558). For example, the monitoring system 102 can determine that the human 140a likely does not have permission to access the secure area 120 in response to determining that the set of images does not include an indication of a non-visible energy signal emitted by a wearable device worn by the human 140a.

The process 550 includes, in response to determining that the images include an indication of a non-visible energy signal emitted by a wearable device worn by a detected human, determining whether a pattern of the non-visible energy signal matches a stored pattern (560). For example, in response to determining that the images include an indication of a non-visible energy signal emitted by a wearable device worn by the human 140b, the monitoring system 102 can compare a pattern of the detected non-visible energy signal to a pattern of a stored non-visible energy signal.

The process 550 includes, in response to determining that the detected non-visible energy signal does not match a stored pattern, determining that the human is not permitted to access the area (558). For example, the monitoring system 102 can determine that a pattern of the non-visible energy signal emitted by the wearable device worn by the human 140b does not match a pattern of a stored non-visible energy signal within a threshold similarity. In response to determining that the pattern of the non-visible energy signal emitted by the wearable device worn by the human 140b does not match the pattern of the stored non-visible energy signal within a threshold similarity, the monitoring system 102 can determine that the human 140b does not have permission to access the secure area.

The process 550 includes, in response to determining that the detected non-visible energy signal matches a stored pattern, determining that the human is permitted to access the area (562). For example, the monitoring system 102 can determine that a pattern of the non-visible energy signal emitted by the wearable device worn by the human 140b matches a pattern of a stored non-visible energy signal within a threshold similarity. In response to determining that the pattern of the non-visible energy signal emitted by the wearable device worn by the human 140b matches the pattern of the stored non-visible energy signal within a threshold similarity, the monitoring system 102 can determine that the human 140b has permission to access the secure area.

The order of operations in the process 550 described above is illustrative only, and can be performed in different orders. For example, the monitoring system 102 can detect the non-visible energy signal in the set of images at the same time as, or before, the monitoring system 102 detects the human depicted in the images. In some examples, some steps can be performed by the monitoring system 102, and other steps can be performed by the camera 130.

In some implementations, the process 550 can include additional operations, fewer operations, or some of the operations can be divided into multiple operations. For example, in some cases, the monitoring system can detect multiple humans in a set of images, and evaluate each detected human, or a subset of two or more humans, simultaneously to determine whether the set of images includes an indication of a non-visible energy signal emitted by a wearable device worn by the human. In some cases, the monitoring system can detect multiple humans in a set of images, and evaluate each detected human sequentially to determine whether the set of images includes an indication of a non-visible energy signal emitted by a wearable device worn by the human.

The disclosed techniques can be used to perform security monitoring for objects other than humans. For example, the disclosed techniques can be applied to animals and vehicles. For example, livestock may wear blanket, jackets, or other clothing or wearable objects that can be embedded with wearable devices that emit and/or reflect non-visible energy. The non-visible energy signals can be used to track and monitor the livestock. In some examples, badges can be attached to vehicles such as cars, trucks, motorcycles, and bicycles. Non-visible energy signals emitted and/or reflected from the badges can be used to monitor vehicle movement and access to secure areas.

The disclosed techniques can be used to perform security monitoring over large physical areas. For example, a site can include multiple areas and multiple imaging devices. The monitoring system 102 can evaluate images generated by the multiple imaging devices in order to track and monitor humans throughout the site.

In an example scenario, each worker at a work site wears a badge that emits a non-visible energy signal with a pattern that is unique to the individual. Two cameras at two different areas of the work site detect a same pattern of non-visible energy at or near the same time. The monitoring system 102 can determine that the two different areas are a distance apart from each other that is too great for a person to travel in the time between the two detections. Therefore, the monitoring system 102 can determine that a possible intruder is present at the work site, in response to determining that the same pattern was detected in the two different areas.

In an example scenario, a network of multiple imaging devices is used to track a vehicle, such as an armored vehicle, as the vehicle travels along roadways. An infrared emitter can be attached to the vehicle. The infrared emitter can emit a particular pattern that is unique to the video. When a camera of the network detects the particular pattern, the camera sends a notification and/or the captured images to a monitoring system. The monitoring system can thus track the vehicle along its travels. If the vehicle is stolen, the network of cameras can be used to locate the stolen vehicle. For example, the monitoring system can send the cameras an instruction to monitor for the particular pattern. When a camera of the network detects the particular pattern, the camera can transmit a notification to the monitoring system 102 and/or activate an alarm.

For situations in which the systems discussed here collect personal information about users, or may make use of personal information, the users may be provided with an opportunity to control whether programs or features collect personal information (e.g., information about a user's social actions or activities, a user's preferences, or a user's current location), or to control whether and/or how the system operates. In addition, certain data may be anonymized in one or more ways before it is stored or used, so that personally identifiable information is removed. For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used.

In this specification, the term “database” is used broadly to refer to any collection of data: the data does not need to be structured in any particular way, or structured at all, and it can be stored on storage devices in one or more locations. A database can be implemented on any appropriate type of memory.

An electronic document, which for brevity will simply be referred to as a document, may, but need not, correspond to a file. A document may be stored in a portion of a file that holds other documents, in a single file dedicated to the document in question, or in multiple coordinated files.

In this specification the term “engine” is used broadly to refer to a software-based system, subsystem, or process that is programmed to perform one or more specific functions. Generally, an engine will be implemented as one or more software modules or components, installed on one or more computers in one or more locations. In some instances, one or more computers will be dedicated to a particular engine. In some instances, multiple engines can be installed and running on the same computer or computers.

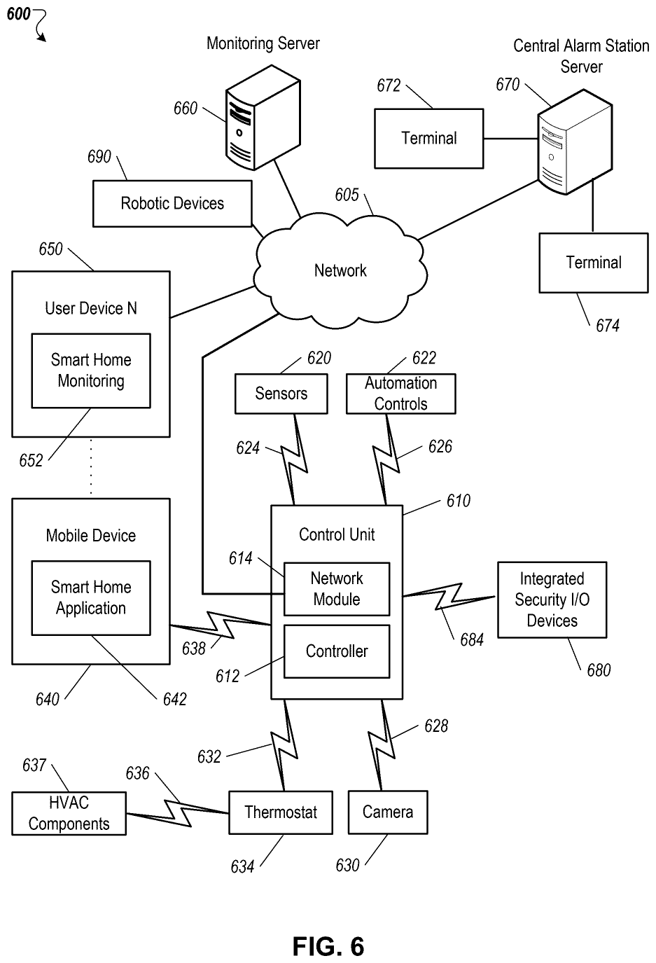

FIG. 6 is a diagram illustrating an example of an environment 600, e.g., for monitoring a property. The property can be any appropriate type of property, such as a home, a business, or a combination of both. The environment 600 includes a network 605, a control unit 610, one or more devices 640 and 650, a monitoring system 660, a central alarm system 670, or a combination of two or more of these. In some examples, the network 605 facilitates communications between two or more of the control unit 610, the one or more devices 640 and 650, the monitoring system 660, and the central alarm system 670.

The network 605 is configured to enable exchange of electronic communications between devices connected to the network 605. For example, the network 605 can be configured to enable exchange of electronic communications between the control unit 610, the one or more devices 640 and 650, the monitoring system 660, and the central alarm system 670. The network 605 can include, for example, one or more of the Internet, Wide Area Networks (“WANs”), Local Area Networks (“LANs”), analog or digital wired and wireless telephone networks (e.g., a public switched telephone network (“PSTN”), Integrated Services Digital Network (“ISDN”), a cellular network, and Digital Subscriber Line (“DSL”)), radio, television, cable, satellite, any other delivery or tunneling mechanism for carrying data, or a combination of these. The network 605 can include multiple networks or subnetworks, each of which can include, for example, a wired or wireless data pathway. The network 605 can include a circuit-switched network, a packet-switched data network, or any other network able to carry electronic communications (e.g., data or voice communications). For example, the network 605 can include networks based on the Internet protocol (“IP”), asynchronous transfer mode (“ATM”), the PSTN, packet-switched networks based on IP, X.25, or Frame Relay, or other comparable technologies and can support voice using, for example, voice over IP (“VoIP”), or other comparable protocols used for voice communications. The network 605 can include one or more networks that include wireless data channels and wireless voice channels. The network 605 can be a broadband network.

The control unit 610 includes a controller 612 and a network module 614. The controller 612 is configured to control a control unit monitoring system, e.g., a control unit system, that includes the control unit 610. In some examples, the controller 612 can include one or more processors or other control circuitry configured to execute instructions of a program that controls operation of a control unit system. In these examples, the controller 612 can be configured to receive input from sensors, or other devices included in the control unit system and control operations of devices at the property, e.g., speakers, displays, lights, doors, other appropriate devices, or a combination of these. For example, the controller 612 can be configured to control operation of the network module 614 included in the control unit 610.

The network module 614 is a communication device configured to exchange communications over the network 605. The network module 614 can be a wireless communication module configured to exchange wireless, wired, or a combination of both, communications over the network 605. For example, the network module 614 can be a wireless communication device configured to exchange communications over a wireless data channel and a wireless voice channel. In some examples, the network module 614 can transmit alarm data over a wireless data channel and establish a two-way voice communication session over a wireless voice channel. The wireless communication device can include one or more of a LTE module, a GSM module, a radio modem, a cellular transmission module, or any type of module configured to exchange communications in any appropriate type of wireless or wired format.

The network module 614 can be a wired communication module configured to exchange communications over the network 605 using a wired connection. For instance, the network module 614 can be a modem, a network interface card, or another type of network interface device. The network module 614 can be an Ethernet network card configured to enable the control unit 610 to communicate over a local area network, the Internet, or a combination of both. The network module 614 can be a voice band modem configured to enable the alarm panel to communicate over the telephone lines of Plain Old Telephone Systems (“POTS”).

The control unit system that includes the control unit 610 can include one or more sensors 620. For example, the environment 600 can include multiple sensors 620. The sensors 620 can include a lock sensor, a contact sensor, a motion sensor, a camera (e.g., a camera 630), a flow meter, any other type of sensor included in a control unit system, or a combination of two or more of these. The sensors 620 can include an environmental sensor, such as a temperature sensor, a water sensor, a rain sensor, a wind sensor, a light sensor, a smoke detector, a carbon monoxide detector, or an air quality sensor, to name a few additional examples. The sensors 620 can include a health monitoring sensor, such as a prescription bottle sensor that monitors taking of prescriptions, a blood pressure sensor, a blood sugar sensor, or a bed mat configured to sense presence of liquid (e.g., bodily fluids) on the bed mat. In some examples, the health monitoring sensor can be a wearable sensor that attaches to a person, e.g., a user, at the property. The health monitoring sensor can collect various health data, including pulse, heartrate, respiration rate, sugar or glucose level, bodily temperature, motion data, or a combination of these. The sensors 620 can include a radio-frequency identification (“RFID”) sensor that identifies a particular article that includes a pre-assigned RFID tag.

The control unit 610 can communicate with a module 622 and a camera 630 to perform monitoring. The module 622 is connected to one or more devices that enable property automation, e.g., home or business automation. For instance, the module 622 can connect to, and be configured to control operation of, one or more lighting systems. The module 622 can connect to, and be configured to control operation of, one or more electronic locks, e.g., control Z-Wave locks using wireless communications in the Z-Wave protocol. In some examples, the module 622 can connect to, and be configured to control operation of, one or more appliances. The module 622 can include multiple sub-modules that are each specific to a type of device being controlled in an automated manner. The module 622 can control the one or more devices using commands received from the control unit 610. For instance, the module 622 can receive a command from the control unit 610, which command was sent using data captured by the camera 630 that depicts an area. In response, the module 622 can cause a lighting system to illuminate an area to provide better lighting in the area, and a higher likelihood that the camera 630 can capture a subsequent image of the area that depicts more accurate data of the area.

The camera 630 can be an image camera or other type of optical sensing device configured to capture one or more images. For instance, the camera 630 can be configured to capture images of an area within a property monitored by the control unit 610. The camera 630 can be configured to capture single, static images of the area; video of the area, e.g., a sequence of images; or a combination of both. The camera 630 can be controlled using commands received from the control unit 610 or another device in the property monitoring system, e.g., a device 650.

The camera 630 can be triggered using any appropriate techniques, can capture images continuously, or a combination of both. For instance, a Passive Infra-Red (“PIR”) motion sensor can be built into the camera 630 and used to trigger the camera 630 to capture one or more images when motion is detected. The camera 630 can include a microwave motion sensor built into the camera which is used to trigger the camera 630 to capture one or more images when motion is detected. The camera 630 can have a “normally open” or “normally closed” digital input that can trigger capture of one or more images when external sensors detect motion or other events. The external sensors can include another sensor from the sensors 620, PIR, or door or window sensors, to name a few examples. In some implementations, the camera 630 receives a command to capture an image, e.g., when external devices detect motion or another potential alarm event or in response to a request from a device. The camera 630 can receive the command from the controller 612, directly from one of the sensors 620, or a combination of both.

In some examples, the camera 630 triggers integrated or external illuminators to improve image quality when the scene is dark. Some examples of illuminators can include Infra-Red, Z-wave controlled “white” lights, lights controlled by the module 622, or a combination of these. An integrated or separate light sensor can be used to determine if illumination is desired and can result in increased image quality.

The camera 630 can be programmed with any combination of time schedule, day schedule, system “arming state”, other variables, or a combination of these, to determine whether images should be captured when one or more triggers occur. The camera 630 can enter a low-power mode when not capturing images. In this case, the camera 630 can wake periodically to check for inbound messages from the controller 612 or another device. The camera 630 can be powered by internal, replaceable batteries, e.g., if located remotely from the control unit 610. The camera 630 can employ a small solar cell to recharge the battery when light is available. The camera 630 can be powered by a wired power supply, e.g., the controller's 612 power supply if the camera 630 is co-located with the controller 612.

In some implementations, the camera 630 communicates directly with the monitoring system 660 over the network 605. In these implementations, image data captured by the camera 630 need not pass through the control unit 610. The camera 630 can receive commands related to operation from the monitoring system 660, provide images to the monitoring system 660, or a combination of both.

The environment 600 can include one or more thermostats 634, e.g., to perform dynamic environmental control at the property. The thermostat 634 is configured to monitor temperature of the property, energy consumption of a heating, ventilation, and air conditioning (“HVAC”) system associated with the thermostat 634, or both. In some examples, the thermostat 634 is configured to provide control of environmental (e.g., temperature) settings. In some implementations, the thermostat 634 can additionally or alternatively receive data relating to activity at a property; environmental data at a property, e.g., at various locations indoors or outdoors or both at the property; or a combination of both. The thermostat 634 can measure or estimate energy consumption of the HVAC system associated with the thermostat. The thermostat 634 can estimate energy consumption, for example, using data that indicates usage of one or more components of the HVAC system associated with the thermostat 634. The thermostat 634 can communicate various data, e.g., temperature, energy, or both, with the control unit 610. In some examples, the thermostat 634 can control the environment, e.g., temperature, settings in response to commands received from the control unit 610.

In some implementations, the thermostat 634 is a dynamically programmable thermostat and can be integrated with the control unit 610. For example, the dynamically programmable thermostat 634 can include the control unit 610, e.g., as an internal component to the dynamically programmable thermostat 634. In some examples, the control unit 610 can be a gateway device that communicates with the dynamically programmable thermostat 634. In some implementations, the thermostat 634 is controlled via one or more modules 622.

The environment 600 can include the HVAC system or otherwise be connected to the HVAC system. For instance, the environment 600 can include one or more HVAC modules 637. The HVAC modules 637 can be connected to one or more components of the HVAC system associated with a property. A module 637 can be configured to capture sensor data from, control operation of, or both, corresponding components of the HVAC system. In some implementations, the module 637 is configured to monitor energy consumption of an HVAC system component, for example, by directly measuring the energy consumption of the HVAC system components or by estimating the energy usage of the one or more HVAC system components by detecting usage of components of the HVAC system. The module 637 can communicate energy monitoring information, the state of the HVAC system components, or both, to the thermostat 634. The module 637 can control the one or more components of the HVAC system in response to receipt of commands received from the thermostat 634.

In some examples, the environment 600 includes one or more robotic devices 690. The robotic devices 690 can be any type of robots that are capable of moving, such as an aerial drone, a land-based robot, or a combination of both. The robotic devices 690 can take actions, such as capture sensor data or other actions that assist in security monitoring, property automation, or a combination of both. For example, the robotic devices 690 can include robots capable of moving throughout a property using automated navigation control technology, user input control provided by a user, or a combination of both. The robotic devices 690 can fly, roll, walk, or otherwise move about the property. The robotic devices 690 can include helicopter type devices (e.g., quad copters), rolling helicopter type devices (e.g., roller copter devices that can fly and roll along the ground, walls, or ceiling) and land vehicle type devices (e.g., automated cars that drive around a property). In some examples, the robotic devices 690 can be robotic devices 690 that are intended for other purposes and merely associated with the environment 600 for use in appropriate circumstances. For instance, a robotic vacuum cleaner device can be associated with the environment 600 as one of the robotic devices 690 and can be controlled to take action responsive to monitoring system events.

In some examples, the robotic devices 690 automatically navigate within a property. In these examples, the robotic devices 690 include sensors and control processors that guide movement of the robotic devices 690 within the property. For instance, the robotic devices 690 can navigate within the property using one or more cameras, one or more proximity sensors, one or more gyroscopes, one or more accelerometers, one or more magnetometers, a global positioning system (“GPS”) unit, an altimeter, one or more sonar or laser sensors, any other types of sensors that aid in navigation about a space, or a combination of these. The robotic devices 690 can include control processors that process output from the various sensors and control the robotic devices 690 to move along a path that reaches the desired destination, avoids obstacles, or a combination of both. In this regard, the control processors detect walls or other obstacles in the property and guide movement of the robotic devices 690 in a manner that avoids the walls and other obstacles.

In some implementations, the robotic devices 690 can store data that describes attributes of the property. For instance, the robotic devices 690 can store a floorplan, a three-dimensional model of the property, or a combination of both, that enable the robotic devices 690 to navigate the property. During initial configuration, the robotic devices 690 can receive the data describing attributes of the property, determine a frame of reference to the data (e.g., a property or reference location in the property), and navigate the property using the frame of reference and the data describing attributes of the property. In some examples, initial configuration of the robotic devices 690 can include learning one or more navigation patterns in which a user provides input to control the robotic devices 690 to perform a specific navigation action (e.g., fly to an upstairs bedroom and spin around while capturing video and then return to a property charging base). In this regard, the robotic devices 690 can learn and store the navigation patterns such that the robotic devices 690 can automatically repeat the specific navigation actions upon a later request.

In some examples, the robotic devices 690 can include data capture devices. In these examples, the robotic devices 690 can include, as data capture devices, one or more cameras, one or more motion sensors, one or more microphones, one or more biometric data collection tools, one or more temperature sensors, one or more humidity sensors, one or more air flow sensors, any other type of sensor that can be useful in capturing monitoring data related to the property and users in the property, or a combination of these. The one or more biometric data collection tools can be configured to collect biometric samples of a person in the property with or without contact of the person. For instance, the biometric data collection tools can include a fingerprint scanner, a hair sample collection tool, a skin cell collection tool, or any other tool that allows the robotic devices 690 to take and store a biometric sample that can be used to identify the person (e.g., a biometric sample with DNA that can be used for DNA testing).

In some implementations, the robotic devices 690 can include output devices. In these implementations, the robotic devices 690 can include one or more displays, one or more speakers, any other type of output devices that allow the robotic devices 690 to communicate information, e.g., to a nearby user or another type of person, or a combination of these.

The robotic devices 690 can include a communication module that enables the robotic devices 690 to communicate with the control unit 610, each other, other devices, or a combination of these. The communication module can be a wireless communication module that allows the robotic devices 690 to communicate wirelessly. For instance, the communication module can be a Wi-Fi module that enables the robotic devices 690 to communicate over a local wireless network at the property. Other types of short-range wireless communication protocols, such as 900 MHz wireless communication, Bluetooth, Bluetooth LE, Z-wave, Zigbee, Matter, or any other appropriate type of wireless communication, can be used to allow the robotic devices 690 to communicate with other devices, e.g., in or off the property. In some implementations, the robotic devices 690 can communicate with each other or with other devices of the environment 600 through the network 605.

The robotic devices 690 can include processor and storage capabilities. The robotic devices 690 can include any one or more suitable processing devices that enable the robotic devices 690 to execute instructions, operate applications, perform the actions described throughout this specification, or a combination of these. In some examples, the robotic devices 690 can include solid-state electronic storage that enables the robotic devices 690 to store applications, configuration data, collected sensor data, any other type of information available to the robotic devices 690, or a combination of two or more of these.

The robotic devices 690 can process captured data locally, provide captured data to one or more other devices for processing, e.g., the control unit 610 or the monitoring system 660, or a combination of both. For instance, the robotic device 690 can provide the images to the control unit 610 for processing. In some examples, the robotic device 690 can process the images to determine an identification of the items.

One or more of the robotic devices 690 can be associated with one or more charging stations. The charging stations can be located at a predefined home base or reference location in the property. The robotic devices 690 can be configured to navigate to one of the charging stations after completion of one or more tasks needed to be performed, e.g., for the environment 600. For instance, after completion of a monitoring operation or upon instruction by the control unit 610, a robotic device 690 can be configured to automatically fly to and connect with, e.g., land on, one of the charging stations. In this regard, a robotic device 690 can automatically recharge one or more batteries included in the robotic device 690 so that the robotic device 690 is less likely to need recharging when the environment 600 requires use of the robotic device 690, e.g., absent other concerns for the robotic device 690.

The charging stations can be contact-based charging stations, wireless charging stations, or a combination of both. For contact-based charging stations, the robotic devices 690 can have readily accessible points of contact to which a robotic device 690 can contact on the charging station. For instance, a helicopter type robotic device can have an electronic contact on a portion of its landing gear that rests on and couples with an electronic pad of a charging station when the helicopter type robotic device lands on the charging station. The electronic contact on the robotic device 690 can include a cover that opens to expose the electronic contact when the robotic device is charging and closes to cover and insulate the electronic contact when the robotic device 690 is in operation.

For wireless charging stations, the robotic devices 690 can charge through a wireless exchange of power. In these instances, a robotic device 690 needs only position itself closely enough to a wireless charging station for the wireless exchange of power to occur. In this regard, the positioning needed to land at a predefined home base or reference location in the property can be less precise than with a contact-based charging station. Based on the robotic devices 690 landing at a wireless charging station, the wireless charging station can output a wireless signal that the robotic device 690 receives and converts to a power signal that charges a battery maintained on the robotic device 690. As described in this specification, a robotic device 690 landing or coupling with a charging station can include a robotic device 690 positioning itself within a threshold distance of a wireless charging station such that the robotic device 690 is able to charge its battery.

In some implementations, one or more of the robotic devices 690 has an assigned charging station. In these implementations, the number of robotic devices 690 can equal the number of charging stations. In these implementations, the robotic devices 690 can always navigate to the specific charging station assigned to that robotic device 690. For instance, a first robotic device can always use a first charging station and a second robotic device can always use a second charging station.

In some examples, the robotic devices 690 can share charging stations. For instance, the robotic devices 690 can use one or more community charging stations that are capable of charging multiple robotic devices 690, e.g., substantially concurrently or separately or a combination of both at different times. The community charging station can be configured to charge multiple robotic devices 690 at substantially the same time, e.g., the community charging station can begin charging a first robotic device and then, while charging the first robotic device, begin charging a second robotic device five minutes later. The community charging station can be configured to charge multiple robotic devices 690 in serial such that the multiple robotic devices 690 take turns charging and, when fully charged, return to a predefined home base or reference location or another location in the property that is not associated with a charging station. The number of community charging stations can be less than the number of robotic devices 690.

In some instances, the charging stations might not be assigned to specific robotic devices 690 and can be capable of charging any of the robotic devices 690. In this regard, the robotic devices 690 can use any suitable, unoccupied charging station when not in use, e.g., when not performing an operation for the environment 600. For instance, when one of the robotic devices 690 has completed an operation or is in need of battery charge, the control unit 610 can reference a stored table of the occupancy status of each charging station and instructs the robotic device to navigate to the nearest charging station that has at least one unoccupied charger.

The environment 600 can include one or more integrated security devices 680. The one or more integrated security devices can include any type of device used to provide alerts based on received sensor data. For instance, the one or more control units 610 can provide one or more alerts to the one or more integrated security input/output devices 680. In some examples, the one or more control units 610 can receive sensor data from the sensors 620 and determine whether to provide an alert, or a message to cause presentation of an alert, to the one or more integrated security input/output devices 680.

The sensors 620, the module 622, the camera 630, the thermostat 634, the module 637, the integrated security devices 680, and the robotic devices 690, can communicate with the controller 612 over communication links 624, 626, 628, 632, 636, 638, 684, and 686. The communication links 624, 626, 628, 632, 636, 638, 684, and 686 can be a wired or wireless data pathway configured to transmit signals between any combination of the sensors 620, the module 622, the camera 630, the thermostat 634, the module 637, the integrated security devices 680, the robotic devices 690, or the controller 612. The sensors 620, the module 622, the camera 630, the thermostat 634, the module 637, the integrated security devices 680, and the robotic devices 690, can continuously transmit sensed values to the controller 612, periodically transmit sensed values to the controller 612, or transmit sensed values to the controller 612 in response to a change in a sensed value, a request, or both. In some implementations, the robotic devices 690 can communicate with the monitoring system 660 over network 605. The robotic devices 690 can connect and communicate with the monitoring system 660 using a Wi-Fi or a cellular connection or any other appropriate type of connection.

The communication links 624, 626, 628, 632, 636, 638, 684, and 686 can include any appropriate type of network, such as a local network. The sensors 620, the module 622, the camera 630, the thermostat 634, the robotic devices 690 and the integrated security devices 680, and the controller 612 can exchange data and commands over the network.

The monitoring system 660 can include one or more electronic devices, e.g., one or more computers. The monitoring system 660 is configured to provide monitoring services by exchanging electronic communications with the control unit 610, the one or more devices 640 and 650, the central alarm system 670, or a combination of these, over the network 605. For example, the monitoring system 660 can be configured to monitor events (e.g., alarm events) generated by the control unit 610. In this example, the monitoring system 660 can exchange electronic communications with the network module 614 included in the control unit 610 to receive information regarding events (e.g., alerts) detected by the control unit 610. The monitoring system 660 can receive information regarding events (e.g., alerts) from the one or more devices 640 and 650.

In some implementations, the monitoring system 660 might be configured to provide one or more services other than monitoring services. In these implementations, the monitoring system 660 might perform one or more operations described in this specification without providing any monitoring services, e.g., the monitoring system 660 might not be a monitoring system as described in the example shown in FIG. 6.

In some examples, the monitoring system 660 can route alert data received from the network module 614 or the one or more devices 640 and 650 to the central alarm system 670. For example, the monitoring system 660 can transmit the alert data to the central alarm system 670 over the network 605.

The monitoring system 660 can store sensor and image data received from the environment 600 and perform analysis of sensor and image data received from the environment 600. Based on the analysis, the monitoring system 660 can communicate with and control aspects of the control unit 610 or the one or more devices 640 and 650.

The monitoring system 660 can provide various monitoring services to the environment 600. For example, the monitoring system 660 can analyze the sensor, image, and other data to determine an activity pattern of a person of the property monitored by the environment 600. In some implementations, the monitoring system 660 can analyze the data for alarm conditions or can determine and perform actions at the property by issuing commands to one or more components of the environment 600, possibly through the control unit 610.

The central alarm system 670 is an electronic device, or multiple electronic devices, configured to provide alarm monitoring service by exchanging communications with the control unit 610, the one or more mobile devices 640 and 650, the monitoring system 660, or a combination of these, over the network 605. For example, the central alarm system 670 can be configured to monitor alerting events generated by the control unit 610. In this example, the central alarm system 670 can exchange communications with the network module 614 included in the control unit 610 to receive information regarding alerting events detected by the control unit 610. The central alarm system 670 can receive information regarding alerting events from the one or more mobile devices 640 and 650, the monitoring system 660, or both.

The central alarm system 670 is connected to multiple terminals 672 and 674. The terminals 672 and 674 can be used by operators to process alerting events. For example, the central alarm system 670, e.g., as part of a first responder system, can route alerting data to the terminals 672 and 674 to enable an operator to process the alerting data. The terminals 672 and 674 can include general-purpose computers (e.g., desktop personal computers, workstations, or laptop computers) that are configured to receive alerting data from a computer in the central alarm system 670 and render a display of information using the alerting data.

For instance, the controller 612 can control the network module 614 to transmit, to the central alarm system 670, alerting data indicating that a sensor 620 detected motion from a motion sensor via the sensors 620. The central alarm system 670 can receive the alerting data and route the alerting data to the terminal 672 for processing by an operator associated with the terminal 672. The terminal 672 can render a display to the operator that includes information associated with the alerting event (e.g., the lock sensor data, the motion sensor data, the contact sensor data, etc.) and the operator can handle the alerting event based on the displayed information. In some implementations, the terminals 672 and 674 can be mobile devices or devices designed for a specific function. Although FIG. 6 illustrates two terminals for brevity, actual implementations can include more (and, perhaps, many more) terminals.

The one or more devices 640 and 650 are devices that can present content, e.g., host and display user interfaces, audio data, or both. For instance, the mobile device 640 is a mobile device that hosts or runs one or more native applications (e.g., the smart property application 642). The mobile device 640 can be a cellular phone or a non-cellular locally networked device with a display. The mobile device 640 can include a cell phone, a smart phone, a tablet PC, a personal digital assistant (“PDA”), or any other portable device configured to communicate over a network and present information. The mobile device 640 can perform functions unrelated to the monitoring system, such as placing personal telephone calls, playing music, playing video, displaying pictures, browsing the Internet, and maintaining an electronic calendar.

The mobile device 640 can include a smart property application 642. The smart property application 642 refers to a software/firmware program running on the corresponding mobile device that enables the user interface and features described throughout. The mobile device 640 can load or install the smart property application 642 using data received over a network or data received from local media. The smart property application 642 enables the mobile device 640 to receive and process image and sensor data from the monitoring system 660.

The device 650 can be a general-purpose computer (e.g., a desktop personal computer, a workstation, or a laptop computer) that is configured to communicate with the monitoring system 660, the control unit 610, or both, over the network 605. The device 650 can be configured to display a smart property user interface 652 that is generated by the device 650 or generated by the monitoring system 660. For example, the device 650 can be configured to display a user interface (e.g., a web page) generated using data provided by the monitoring system 660 that enables a user to perceive images captured by the camera 630, reports related to the monitoring system, or both. Although FIG. 6 illustrates two devices for brevity, actual implementations can include more (and, perhaps, many more) or fewer devices.

In some implementations, the one or more devices 640 and 650 communicate with and receive data from the control unit 610 using the communication link 638. For instance, the one or more devices 640 and 650 can communicate with the control unit 610 using various wireless protocols, or wired protocols such as Ethernet and USB, to connect the one or more devices 640 and 650 to the control unit 610, e.g., local security and automation equipment. The one or more devices 640 and 650 can use a local network, a wide area network, or a combination of both, to communicate with other components in the environment 600. The one or more devices 640 and 650 can connect locally to the sensors and other devices in the environment 600.

Although the one or more devices 640 and 650 are shown as communicating with the control unit 610, the one or more devices 640 and 650 can communicate directly with the sensors and other devices controlled by the control unit 610. In some implementations, the one or more devices 640 and 650 replace the control unit 610 and perform one or more of the functions of the control unit 610 for local monitoring and long range, offsite, or both, communication.

In some implementations, the one or more devices 640 and 650 receive monitoring system data captured by the control unit 610 through the network 605. The one or more devices 640 and 650 can receive the data from the control unit 610 through the network 605, the monitoring system 660 can relay data received from the control unit 610 to the one or more devices 640 and 650 through the network 605, or a combination of both. In this regard, the monitoring system 660 can facilitate communication between the one or more devices 640 and 650 and various other components in the environment 600.

In some implementations, the one or more devices 640 and 650 can be configured to switch whether the one or more devices 640 and 650 communicate with the control unit 610 directly (e.g., through communication link 638) or through the monitoring system 660 (e.g., through network 605) based on a location of the one or more devices 640 and 650. For instance, when the one or more devices 640 and 650 are located close to, e.g., within a threshold distance of, the control unit 610 and in range to communicate directly with the control unit 610, the one or more devices 640 and 650 use direct communication. When the one or more devices 640 and 650 are located far from, e.g., outside the threshold distance of, the control unit 610 and not in range to communicate directly with the control unit 610, the one or more devices 640 and 650 use communication through the monitoring system 660.

Although the one or more devices 640 and 650 are shown as being connected to the network 605, in some implementations, the one or more devices 640 and 650 are not connected to the network 605. In these implementations, the one or more devices 640 and 650 communicate directly with one or more of the monitoring system components and no network (e.g., Internet) connection or reliance on remote servers is needed.

In some implementations, the one or more devices 640 and 650 are used in conjunction with only local sensors and/or local devices in a house. In these implementations, the environment 600 includes the one or more devices 640 and 650, the sensors 620, the module 622, the camera 630, and the robotic devices 690. The one or more devices 640 and 650 receive data directly from the sensors 620, the module 622, the camera 630, the robotic devices 690, or a combination of these, and send data directly to the sensors 620, the module 622, the camera 630, the robotic devices 690, or a combination of these. The one or more devices 640 and 650 can provide the appropriate interface, processing, or both, to provide visual surveillance and reporting using data received from the various other components.

In some implementations, the environment 600 includes network 605 and the sensors 620, the module 622, the camera 630, the thermostat 634, and the robotic devices 690 are configured to communicate sensor and image data to the one or more devices 640 and 650 over network 605. In some implementations, the sensors 620, the module 622, the camera 630, the thermostat 634, and the robotic devices 690 are programmed, e.g., intelligent enough, to change the communication pathway from a direct local pathway when the one or more devices 640 and 650 are in close physical proximity to the sensors 620, the module 622, the camera 630, the thermostat 634, the robotic devices 690, or a combination of these, to a pathway over network 605 when the one or more devices 640 and 650 are farther from the sensors 620, the module 622, the camera 630, the thermostat 634, the robotic devices 690, or a combination of these.

In some examples, the monitoring system 660 leverages GPS information from the one or more devices 640 and 650 to determine whether the one or more devices 640 and 650 are close enough to the sensors 620, the module 622, the camera 630, the thermostat 634, the robotic devices 690, or a combination of these, to use the direct local pathway or whether the one or more devices 640 and 650 are far enough from the sensors 620, the module 622, the camera 630, the thermostat 634, the robotic devices 690, or a combination of these, that the pathway over network 605 is required. In some examples, the monitoring system 660 leverages status communications (e.g., pinging) between the one or more devices 640 and 650 and the sensors 620, the module 622, the camera 630, the thermostat 634, the robotic devices 690, or a combination of these, to determine whether communication using the direct local pathway is possible. If communication using the direct local pathway is possible, the one or more devices 640 and 650 communicate with the sensors 620, the module 622, the camera 630, the thermostat 634, the robotic devices 690, or a combination of these, using the direct local pathway. If communication using the direct local pathway is not possible, the one or more devices 640 and 650 communicate with the sensors 620, the module 622, the camera 630, the thermostat 634, the robotic devices 690, or a combination of these, using the pathway over network 605.

In some implementations, the environment 600 provides people with access to images captured by the camera 630 to aid in decision-making. The environment 600 can transmit the images captured by the camera 630 over a network, e.g., a wireless WAN, to the devices 640 and 650. Because transmission over a network can be relatively expensive, the environment 600 can use several techniques to reduce costs while providing access to significant levels of useful visual information (e.g., compressing data, down-sampling data, sending data only over inexpensive LAN connections, or other techniques).

In some implementations, a state of the environment 600, one or more components in the environment 600, and other events sensed by a component in the environment 600 can be used to enable/disable video/image recording devices (e.g., the camera 630). In these implementations, the camera 630 can be set to capture images on a periodic basis when the alarm system is armed in an “away” state, set not to capture images when the alarm system is armed in a “stay” state or disarmed, or a combination of both. In some examples, the camera 630 can be triggered to begin capturing images when the control unit 610 detects an event, such as an alarm event, a door-opening event for a door that leads to an area within a field of view of the camera 630, or motion in the area within the field of view of the camera 630. In some implementations, the camera 630 can capture images continuously, but the captured images can be stored or transmitted over a network when needed.

Although FIG. 6 depicts the monitoring system 660 as remote from the control unit 610, in some examples the control unit 610 can be a component of the monitoring system 660. For instance, both the monitoring system 660 and the control unit 610 can be physically located at a property that includes the sensors 620 or at a location outside the property.

In some examples, some of the sensors 620, the robotic devices 690, or a combination of both, might not be directly associated with the property. For instance, a sensor or a robotic device might be located at an adjacent property or on a vehicle that passes by the property. A system at the adjacent property or for the vehicle, e.g., that is in communication with the vehicle or the robotic device, can provide data from that sensor or robotic device to the control unit 610, the monitoring system 660, or a combination of both.

A number of implementations have been described. Nevertheless, it will be understood that various modifications can be made without departing from the spirit and scope of the disclosure. For example, various forms of the flows shown above can be used, with operations re-ordered, added, or removed.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, a data processing apparatus. Alternatively or in addition, the program instructions can be encoded on an artificially-generated propagated signal, e.g., a machine-generated electrical, optical, or electromagnetic signal, that is generated to encode information for transmission to a suitable receiver apparatus for execution by a data processing apparatus. One or more computer storage media can include a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can be or include special purpose logic circuitry, e.g., a field programmable gate array (“FPGA”) or an application-specific integrated circuit (“ASIC”). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can be performed by, and apparatus can also be implemented as, special purpose logic circuitry, e.g., a field programmable gate array (“FPGA”) or an application-specific integrated circuit (“ASIC”).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. A computer can be embedded in another device, e.g., a mobile telephone, a smart phone, a headset, a personal digital assistant (“PDA”), a mobile audio or video player, a game console, a Global Positioning System (“GPS”) receiver, or a portable storage device, e.g., a universal serial bus (“USB”) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a liquid crystal display (“LCD”), an organic light emitting diode (“OLED”) or other monitor, for displaying information to the user and a keyboard and a pointing device, e.g., a mouse or a trackball or a touchscreen, by which the user can provide input to the computer. Other kinds of devices can be used to provide for interaction with a user as well. For example, feedback provided to the user can be any form of sensory feedback, e.g., visual feedback, auditory feedback, or tactile feedback; and input from the user can be received in any form, including acoustic, speech, or tactile input. In some examples, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an Hypertext Markup Language (“HTML”) page, to a user device, e.g., for purposes of displaying data to and receiving user input from a user device, which acts as a client. Data generated at the user device, e.g., a result of user interaction with the user device, can be received from the user device at the server.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some instances be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the invention have been described. Other implementations are within the scope of the following claims. For example, the operations recited in the claims, described in the specification, or depicted in the figures can be performed in a different order and still achieve desirable results. In some implementations, multitasking and parallel processing may be advantageous.

What is claimed is:

1. A method comprising:
obtaining, from an imaging device, a set of images of one or more physical locations surrounding or including an area of a property;
detecting a human depicted in the set of images;
determining whether the set of images includes an indication of a non-visible energy signal emitted by a wearable device worn by the human; and
determining that the human has permission to access the area of the property in response to determining that the set of images includes the indication of the non-visible energy signal emitted by the wearable device worn by the human.

2. The method of claim 1, comprising:
obtaining, from the imaging device, a second set of images of the area of the property;
detecting a second human in the second set of images;
determining whether the second set of images includes an indication of a non-visible energy signal emitted by a second wearable device worn by the second human; and
determining that the second human does not have permission to access the area of the property in response to determining that the set of images does not include the indication of the non-visible energy signal emitted by the wearable device worn by the second human.

3. The method of claim 1, wherein determining that the human has permission to access the area of the property comprises:
in response to determining that the set of images includes the indication of the non-visible energy signal emitted by the wearable device worn by the human, detecting a pattern of the non-visible energy signal;
comparing the pattern of the non-visible energy signal to a set of stored patterns of non-visible energy signals; and
determining that the human has permission to access the area of the property in response to (a) determining that the set of images includes the indication of the non-visible energy signal emitted by the wearable device worn by the human and (b) determining that the pattern of the non-visible energy signal matches a stored pattern of the set of stored patterns of non-visible energy signals.

4. The method of claim 3, wherein the pattern of the non-visible energy signal comprises a time-varying pattern detected over multiple images of the set of images.

5. The method of claim 3, wherein the pattern of the non-visible energy signal comprises a graphical pattern detected in an image of the set of images.

6. The method of claim 3, wherein determining that the pattern of the non-visible energy signal matches the stored pattern comprises determining that the pattern of the non-visible energy signal matches the stored pattern within a threshold similarity.

7. The method of claim 3, wherein the set of stored patterns correspond to one or more character encoding systems.

8. The method of claim 7, wherein the one or more character encoding systems includes at least one of Morse code, Baudot code, or tap code.

9. The method of claim 1, wherein determining that the human has permission to access the area of the property comprises:
in response to determining that the set of images includes the indication of the non-visible energy signal emitted by the wearable device worn by the human, detecting a signal characteristic of the non-visible energy signal;
comparing the signal characteristic of the non-visible energy signal to a set of stored signal characteristics of non-visible energy signals; and
determining that the human has permission to access the area of the property in response to (a) determining that the set of images includes the indication of the non-visible energy signal emitted by the wearable device worn by the human and (b) determining that the signal characteristic of the non-visible energy signal matches a stored signal characteristic of the set of stored signal characteristics of non-visible energy signals.

10. The method of claim 9, wherein the signal characteristic of the non-visible energy signal comprises at least one of a frequency, an amplitude, a wavelength, a pulse width, and a pulse repetition frequency.

11. The method of claim 9, wherein determining that the signal characteristic of the non-visible energy signal matches the stored signal characteristic comprises determining that the signal characteristic of the non-visible energy signal matches the stored signal characteristic within a threshold similarity.

12. The method of claim 1, wherein:
the area of the property comprises an outdoor area; and
the imaging device comprises an outdoor imaging device that is physically located within a threshold distance of the outdoor area.

13. The method of claim 1, wherein the non-visible energy signal comprises an electromagnetic signal having a wavelength that is imperceptible to a human eye.

14. The method of claim 1, wherein the non-visible energy signal comprises radio energy, microwave energy, infrared energy, ultraviolet energy, x-ray energy, or gamma energy.

15. The method of claim 1, wherein the non-visible energy signal comprises acoustic energy.

16. The method of claim 1, wherein the imaging device is configured to generate images from detection of non-visible energy.

17. One or more computer storage media encoded with instructions that, when executed by one or more computers, cause the one or more computers to perform operations comprising:
obtaining, from an imaging device, a set of images of one or more physical locations surrounding or including an area of a property;
detecting a human depicted in the set of images;
determining whether the set of images includes an indication of a non-visible energy signal emitted by a wearable device worn by the human; and
determining that the human has permission to access the area of the property in response to determining that the set of images includes the indication of the non-visible energy signal emitted by the wearable device worn by the human.

18. The one or more computer storage media of claim 17, the operations comprising:
obtaining, from the imaging device, a second set of images of the area of the property;
detecting a second human in the second set of images;
determining whether the second set of images includes an indication of a non-visible energy signal emitted by a second wearable device worn by the second human; and
determining that the second human does not have permission to access the area of the property in response to determining that the set of images does not include the indication of the non-visible energy signal emitted by the wearable device worn by the second human.

19. The one or more computer storage media of claim 17, wherein determining that the human has permission to access the area of the property comprises:
in response to determining that the set of images includes the indication of the non-visible energy signal emitted by the wearable device worn by the human, detecting a pattern of the non-visible energy signal;
comparing the pattern of the non-visible energy signal to a set of stored patterns of non-visible energy signals; and
determining that the human has permission to access the area of the property in response to (a) determining that the set of images includes the indication of the non-visible energy signal emitted by the wearable device worn by the human and (b) determining that the pattern of the non-visible energy signal matches a stored pattern of the set of stored patterns of non-visible energy signals.

20. A system comprising one or more computers and one or more storage devices on which are stored instructions that are operable, when executed by the one or more computers, to cause the one or more computers to perform operations comprising:
obtaining, from an imaging device, a set of images of one or more physical locations surrounding or including an area of a property;
detecting a human depicted in the set of images;
determining whether the set of images includes an indication of a non-visible energy signal emitted by a wearable device worn by the human; and
determining that the human has permission to access the area of the property in response to determining that the set of images includes the indication of the non-visible energy signal emitted by the wearable device worn by the human.
